(19) United States
(12) Patent Application Publication
(10) Pub. No.: US 2016/0162131 A1
(43) Pub. Date: Jun. 9, 2016

(54) SOCIAL NETWORK

(71) Applicants: Etzer Zamor, North Miami, FL (US); Jean Marc Jerome, North Miami, FL (US)

(72) Inventors: Etzer Zamor, North Miami, FL (US); Jean Marc Jerome, North Miami, FL (US)

(21) Appl. No.: 14/962,278

(22) Filed: Dec. 8, 2015

Related U.S. Application Data
(60) Provisional application No. 62/088,979, filed on Dec. 8, 2014.

(51) Int. Cl. G06F 3/0482; G06F 3/0486; G06F 3/0484; H04L 29/08; H04L 29/06

(52) U.S. Cl. CPC G06F 3/0482; H04L 67/306; H04L 63/10; G06F 3/04842; G06F 3/0486

(57) ABSTRACT

A social networking platform including navigation and organizational improvements including segmented ring navigator, color coding status of recognized other users, scrolling ticker information bars and other features.

### RELATED APPLICATIONS

Benefit is claimed of provisional patent application titled “Social Network” having serial number USPTO 62/088,979 filed on 8 Dec. 2015 and is incorporated herein by reference.

### BACKGROUND OF THE INVENTION

1. Field of the Invention

The present invention relates to computing, and more particularly, to structure, functionality and organization of online social networking and related websites.

2. Description of the Related Art

Many designs for social networking websites have been designed in the past. None of them however, include a navigation system with a center profile surrounded by segments where segments are each a sub-set of the center or navigate to another selector. Other unique features include a ticker constantly providing information to the user, color coding avatar frames to convey information, on screen navigation tabs that are drag and drop moveable and complex privacy settings with access levels for varying classes of correspondent users.

Other patents describing the closest subject matter provide for a number of more or less complicated features that fail to solve the problem in an efficient and economical way. None of these prior art designs suggest the novel features of the present invention.

### SUMMARY OF THE INVENTION

It is one of the main objects of the present invention to provide a social networking interface that has improved navigation controls throughout the site.

It is another object of this invention to provide a secure social networking environment that is controllable by the user to permit or deny access of specific information or assign classes of information associated with a particular access level.

It is still another object of the present invention to provide a social networking system for any type of social grouping that effectively integrates the end user with vendors or service providers that acutely relate to that user.

It is yet another object of this invention to provide such a social networking system that is inexpensive to deploy and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 shows a sample screen shot demonstrating a version of a navigational frame.

FIG. 2 shows a sample screen shot of a version of an activity page combining several elements.

FIG. 3 shows a sample screen shot of an iteration of a page prominently displaying a background theme.

FIG. 4 shows a sample screen shot including an example of a navigational ring.

### DETAILED DESCRIPTION OF THE PREFERRED EMBODIMENT

Referring now to the drawings, where the present invention is generally referred to with numeral 10, it can be observed that it basically includes a mobile computing platform with a display for use in social networks or other computer-human interface for navigation and use of software.

The present invention, in one version, is applied to a social network application functionally designed as a collection of mobile and web apps. The social media module of the network is packed with several distinguishing features that are specifically designed to give the user a navigation friendly and enjoyable experience. The combination and application of those features are very distinct and unique in nature and provide an enhanced user experience.

1. Navigational Ring

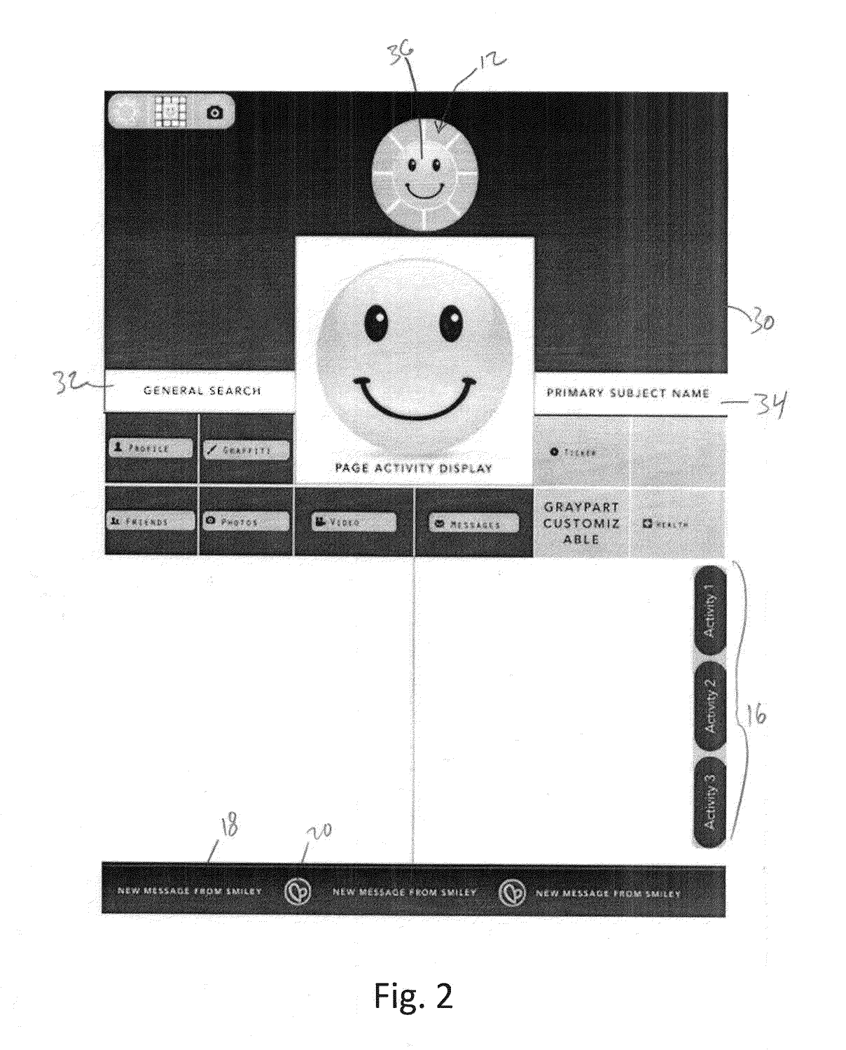

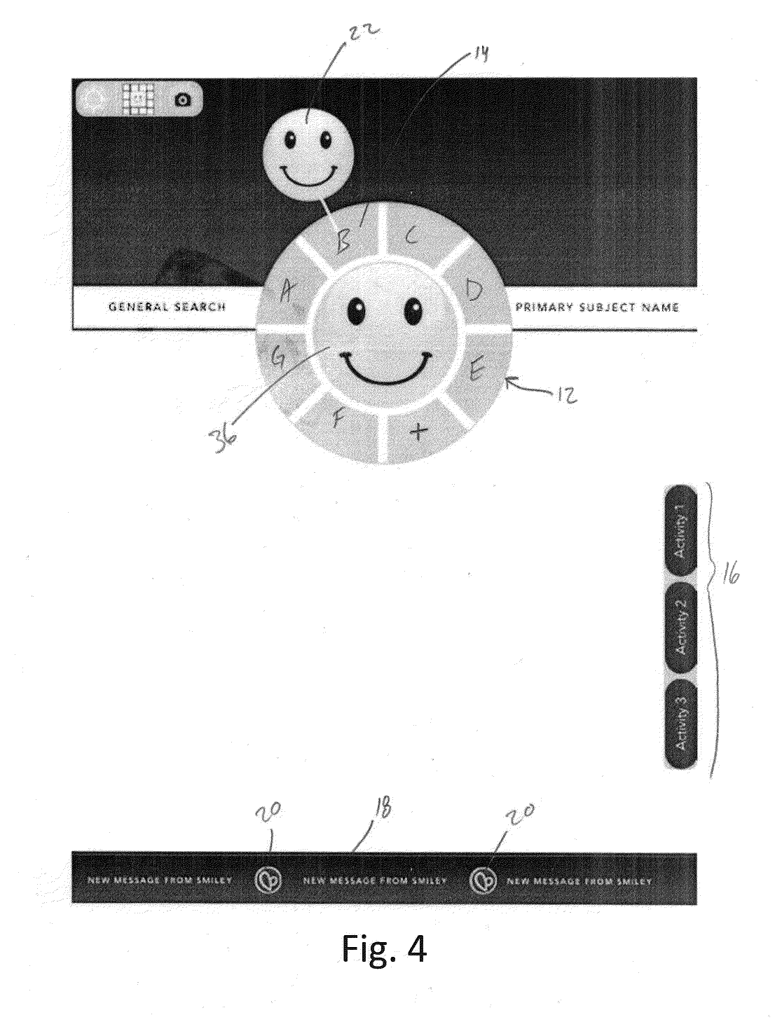

The navigational ring 12 is at the top center of an example of a user home screen version shown generally in FIG. 4. Beside the home screen (FIG. 4) and the profile screen (FIG. 2), as the user navigates throughout the network, the navigational ring 12 can be dragged to any convenient location on the screen.

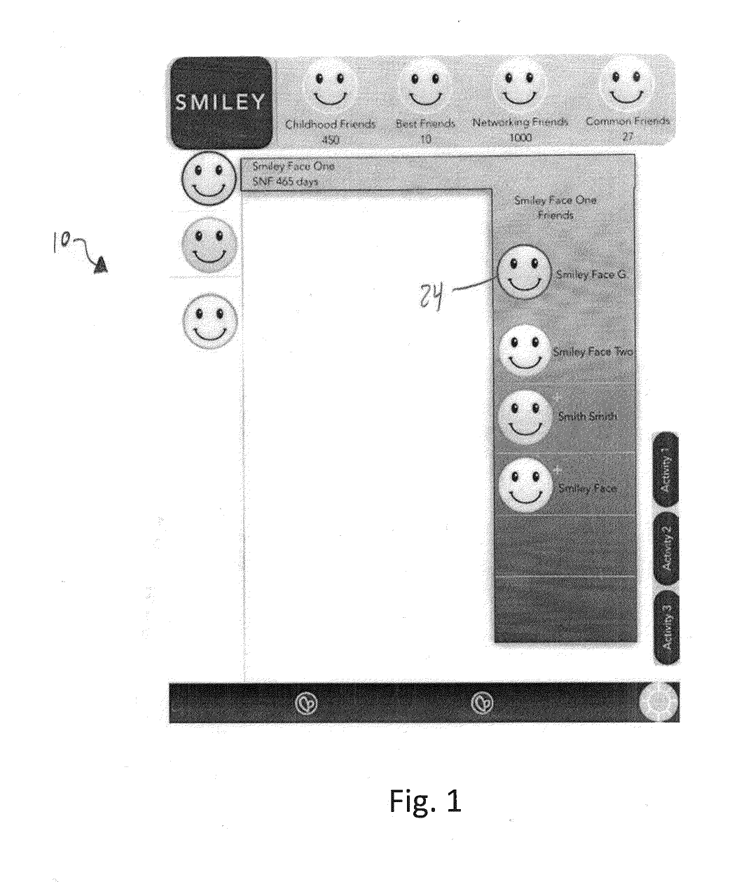

For example, when a navigation decision is anticipated by the application the navigational ring 12 may be displayed more prominently as seen in FIG. 4. Conversely, where the limited resources of screen real estate is needed for other current tasks then the navigational ring 12 could be minimal as seen in FIG. 1.

In addition, the subject images 14 within the ring can zoom 22 into an expanded view, for example when touched or hovered over and zoom out when not hovered over. This behavior can be triggered by different selecting means depending whether the user is using the mobile app or the web app. Depending on the circumstances a hovering mouse pointer or a light touch on a touch screen or other available indicator that the user is inspecting that element.

2. Navigation Tabs History

The several tabs 16 on the right side of the active screen shown in FIG. 2 is the history of the previous several screens that the user has visited. Obviously there could be more or less than three and remain suitable but three is an effective number for a screen of this size. These tabs 16 are conveniently placed in case the user wants to navigate back to these previous activities.

3. Ticker Bar

A ticker bar 18 of messages will scroll at the bottom of the current active screen. These messages will be separated by a small graphics 20 that is an advertiser logo. This combination of user specific information and advertising helps draw the user's eye to the ads thereby making the ads more effective.

The user can customize the ticker bar 18 to include information that they deem more important. For example, some users may prefer to have news updates, changes in friend status, incoming message subject lines or other such information in the ticker bar 18.

The content of the ticker bar 18 can also be customized for the area of the social network site. For example, when in a messaging section the user is more likely to be interested in friend status. Alternately, while a user is browsing general pages then a news feed may be more appropriately displayed.

The application can determine automatically, in one version, what the user is more likely to find useful and make default settings without burdening the user. The user preferably retains the control over the application to override any automatic settings to make the experience more customized.

4. Friend Image Frame Online Status

On the friend screen, such as that shown in FIG. 1, the friend image 24 frame changes color indicating the online status of the friend. Red means offline. Green means online. Orange means online with no activities for at least ten minutes.

These colors are merely example of effective hues that could vary depending on the settings of the application. It is important to convey their meaning that the colors are distinguishable by the user to convey the status of a friend.

Colors can also be adapted to have other significance. For example, a particular hue could indicate that a guest has requested friendship status or is presently online and inviting any available friend to contact them for communications or other reasons.

5. Messages with Ad as Background Image

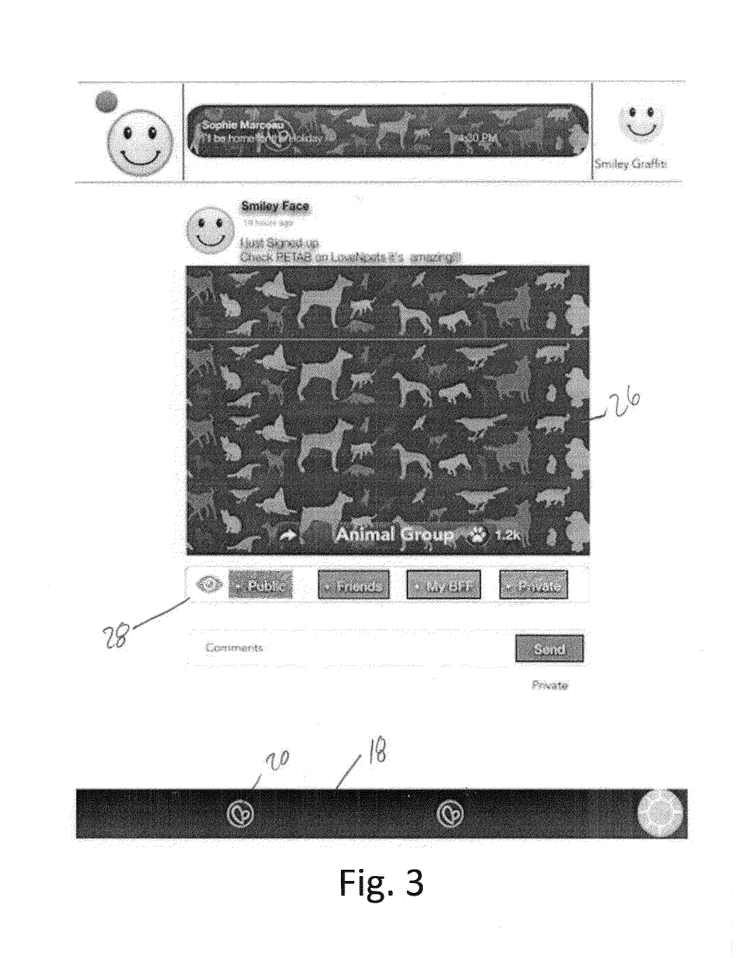

A user can select an image from a stock of pre-loaded images to represent the background 26 image behind of his/her messages such as demonstrated in FIG. 3. Each image in the stock of pre-loaded images is a premium ad. If the user decides not select any images, the default image which represents a preselected ad or provider of the software will be displayed.

6. Privacy Settings

Each user will have a choice to select a privacy setting 28 for each subject profile on that user account as seen in FIG. 3. In addition, each user can further select a privacy setting 28 for all comments that will be made by the user. The user has a choice to select one out of four privacy settings 28 either (Public, Friends, MyBFF, Private).

The creation of an online community of those with a common interest, such as pet owners and pet related businesses, is created by the social network where they maintain their personal/business profiles and their pets' profiles through one single platform. The main objective of the social network is to create a shield for our users where the business services on the network will be measured by user-based reviews. This will be accomplished via the One-Click Method (OCM).
a) One click to access your personal/business profile
b) One click to access your pet profile
c) One click to access your pet services

It should be appreciated that any subject or common bonds that link those members of a social network could be used. An example shown here is for a pet or animal lover type of community but that should not be interpreted as limiting.

How will the business model work?

It is important to build a high quality user interface with all the features of modern social media network and services platform that further include the present improvements.

The social network site should generate high volume of traffic based on the quality of the users and special promotions that can be applied for specific periods and to drive a particular type of individual users and/or commercial users.

With high traffic volume a critical mass will be established that self-perpetuates the business model without revenue negative promotions. It is expected that businesses will join more readily and quickly then closely followed by advertisers and other revenue positive business members or income providers.

The new social network business model brings many benefits that differentiate from the prior art. Some of the benefits are as listed:
a) One single point of contact for subject specific advertisers;
b) User-based reviews will change the behavior of pet-related businesses by enhancing the level of standards of services in the industry;
c) The ability to drill down to a specific profile in our database by any properties in order to create targeted ads;
d) Monetize the network for our users with an e-Commerce application where a broader, purpose based marketplace can be established that caters to the interests of the members. For example pet supply and veterinarian service providers may be ideal. Other options could be more indirect like physical gatherings, trade shows or other things that could lead to connections of users of the social network to commercial providers of goods and services.

Graffiti Screen

This is the home screen of the account user. An example is seen in figure, however, many other effective forms are possible and this is merely an example. The top of the Graffiti screen comprises of a rectangle with a customized background 30. A Search button 32 will be displayed, for example at the bottom left of the rectangle. The name of the account owner 34 is displayed, for example at the bottom right of the rectangle. The ring/square 12 is displayed, for example at the center the rectangle with its bottom line splits the ring/square in half.

Ring/Square Concept

The profile ring/square 12 (FIG. 4) is where the primary subject profile can be accessed via one click and is located at the center 36 of the ring/square surrounded by eight segments 14. Each segment 14 is the secondary subject directly related to the primary subject. Each secondary subject's profile can be accessed via one click. The ring only displays the first seven segments. The eighth segment is reserved only if there exists more than seven secondary subjects. A “+” in the eighth segment indicates that there are more than seven secondary subjects available to be displayed. Furthermore, the ring 12 features zoom in and out of the subjects as follows:

Web App Behavior—As the mouse scrolls on the subject it will zoom in (enlarge). As the mouse scrolls away from the subject it will zoom out (reduce). One click on a segment of the ring will take you to the subject profile.

Mobile App Behavior—Touch and hold to zoom in (enlarge) the subject. Release will zoom out (reduce) the subject. Quick touch (one click) will access the subject profile.

Although a circular ring 12 is shown in the figures and having eight segments around the periphery, other shapes and configurations may also be effective. For example, square, octagonal or other geometric shapes could be similarly effective. Likewise the number of segments has been found be effective when eight are present, more or less may be suitable depending on the applications of the software, the particular screen or nature of the social network.

Graphics will be provided for at least some of the following screens:
Message screen
Photo/video screen
Friends screen
Calendar
Events

A version of the social network platform can be fairly described as including a graphical navigation device comprising a circular or square first image (other shapes are also equally possible) centered within segmented arcs, essentially framing or bordering the central first image. The segmented arcs (or lines) are immediately adjacent to and encircle the first image. The segmented arcs are typically evenly spaced about the first image but not necessarily. Each segmented arc is a link to a predetermined page on the social network platform, for example, another user, a vendor, settings, external links or other places. An optional scrolling ticker conveys text information at an edge of a viewing area. The ticker could show changes in status of other users, news or other alerts. The text information in the ticker is periodically interrupted with an advertisement. This helps drive the user's eyes to the ads because they are looking at the news and can't help but see the ads. Avatars of other users are surrounded by a frame with predetermined color that conveys an information about the avatar. For example that they are available, looking for contact, unavailable, happy, sad or other bit of communication. An optional set of navigation tabs are visible and are drag and drop moveable on the viewing area. Each navigation tab of the set of navigation tabs is a link to a predetermined page on the social network platform or outside the site. A user of the social network platform is assigned an access level for every other user of the social network platform. Access levels dictate how much information is available to that user. There may be multiple levels. For example, there may be some public information and some more private that is not available to anyone but those with the most intimate relationship with that user. The user will be permitted access or denied information of a second user depending on the access level of the user. A vendor page includes an information about a commercial user that is relevant to the interests of the user. For example if the user is interested in animals then there may be information about veterinarians or pet food. The vendor page displays a rating of the vendor, typically derived from other member ratings based on experiences with that vender. A background of the viewing area contains a second advertisement image, similar to a watermark.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A social network platform comprising:
a navigation device comprising a circular or square first image centered within segmented arcs;
the segmented arcs are immediately adjacent to and encircles the first image;
the segmented arcs are evenly spaced about the first image;
each segmented arc is a link to a predetermined page on the social network platform;
a scrolling ticker conveys text information at an edge of a viewing area;
the text information in the ticker is periodically interrupted with an advertisement;
avatars of other users are surrounded by a frame with predetermined color that conveys an information about the avatar;
a set of navigation tabs are visible and are drag and drop moveable on the viewing area;
each navigation tab of the set of navigation tabs is a link to a predetermined page on the social network platform;
a user of the social network platform is assigned an access level for every other user of the social network platform;
the user will be permitted access or denied information of a second user depending on the access level of the user;
a vendor page includes an information about a commercial user that is relevant to the interests of the user;
the vendor page displays a rating of the vendor;
a background of the viewing area contains a second advertisement.

2. The social network platform as in claim 1 further comprising the color of the frame surrounding the avatar indicates a status of an owner of the avatar selected from any of: available, unavailable, availability undisclosed or no recent activity.

3. The social network platform as in claim 1 further comprising the user may set a preference of the nature of content of the text information in the ticker.

4. The social network platform as in claim 1 further comprising any of the segmented arcs are a link to a different user profile and the first image is a link to the user profile.

5. A social network platform comprising:
a navigation device comprising a circular or square first image centered within segmented arcs;
the segmented arcs are immediately adjacent to and encircles the first image;
the segmented arcs are evenly spaced about the first image;
any of the segmented arcs are a link to a different user profile and the first image is a link to the user profile;
a scrolling ticker conveys text information at an edge of a viewing area;
the text information in the ticker is periodically interrupted with an advertisement;
the user may set a preference of the nature of content of the text information in the ticker avatars of other users are surrounded by a frame with predetermined color that conveys an information about the avatar;
the color of the frame surrounding the avatar indicates a status of an owner of the avatar selected from any of: available, unavailable, availability undisclosed or no recent activity
a set of navigation tabs are visible and are drag and drop moveable on the viewing area;
each navigation tab of the set of navigation tabs is a link to a predetermined page on the social network platform;
a user of the social network platform is assigned an access level for every other user of the social network platform;
the user will be permitted access or denied information of a second user depending on the access level of the user;
a vendor page includes an information about a commercial user that is relevant to the interests of the user;
the vendor page displays a rating of the vendor;
a background of the viewing area contains a second advertisement.
